(19) United States
(12) Patent Application Publication
(10) Pub. No.: US 2013/0195113 A1
(43) Pub. Date: Aug. 1, 2013

(54) System and Method for Network Switch Data Plane Virtualization

(71) Applicants: Saikrishna Kotha, Austin, TX (US); Gaurav Chawla, Austin, TX (US); Rajesh Narayanan, San Jose, CA (US)

(72) Inventors: Saikrishna Kotha, Austin, TX (US); Gaurav Chawla, Austin, TX (US); Rajesh Narayanan, San Jose, CA (US)

(73) Assignee: DELL PRODUCTS, LP, Round Rock, TX (US)

(21) Appl. No.: 13/361,509

(22) Filed: Jan. 30, 2012

(51) Int. Cl. H04L 12/56

(52) U.S. Cl. 370/401

(57) ABSTRACT

A network switching device includes a hardware data plane with a forwarding table. The forwarding table has a sub-table. The network switching device also includes a control plane with a processor and a virtual data plane. The virtual data plane has a virtual sub-table. The processor maps changes in the virtual sub-table to the sub-table.

### FIELD OF THE DISCLOSURE

The present disclosure generally relates to information handling systems, and more particularly relates to data plane virtualization in a network switch.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, and networking systems. Information handling systems can also implement various virtualized architectures.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a network switching device according to an embodiment of the present disclosure;

FIG. 2 is a block diagram of a network environment including a network switching device similar to the network switching device of FIG. 1, according to an embodiment of the present disclosure;

FIGS. 3 and 4 are block diagrams of a network environment similar to the network environment of FIG. 2, according to another embodiment of the present disclosure;

FIG. 5 is a flowchart illustrating a method of data plane virtualization in a network switching device according to an embodiment of the present disclosure; and

FIG. 6 is a block diagram illustrating an information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

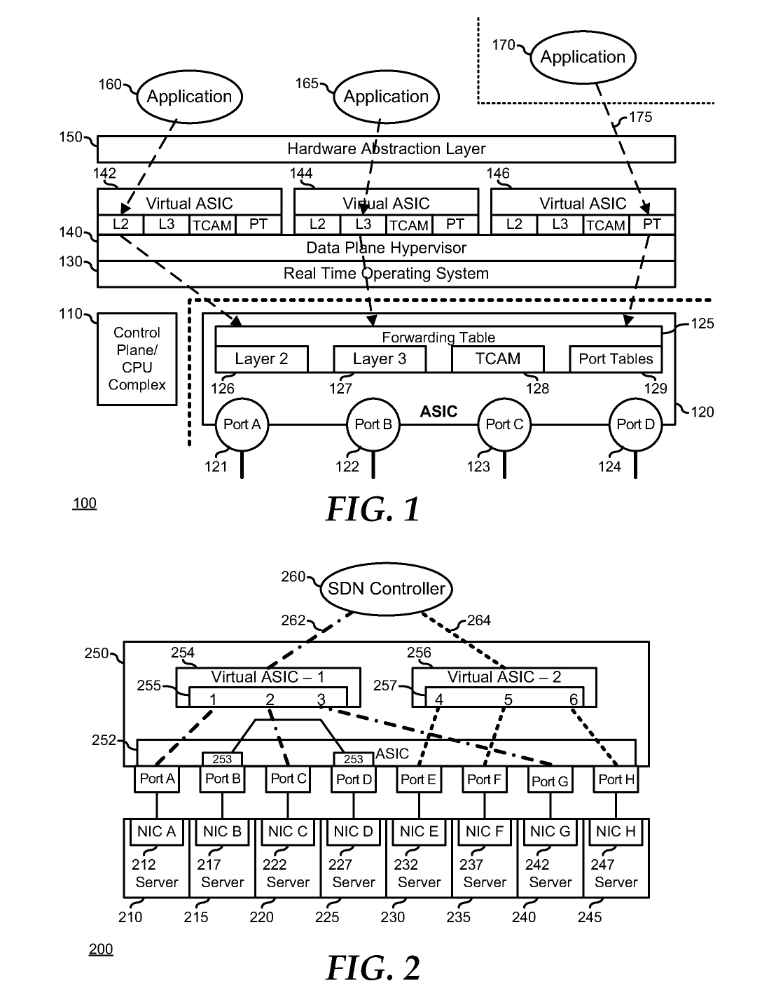

FIG. 1 illustrates a network switching device 100 that can include one or more information handling systems. For purposes of this disclosure, the information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network server or storage device, a switch router or other network communication device, or any other suitable device and may vary in size, shape, performance, functionality, and price. The information handling system may include memory, one or more processing resources such as a central processing unit (CPU) or hardware or software control logic, and operates to execute code. Additional components of the information handling system may include one or more storage devices that can store code, one or more communications ports for communicating with external devices as well as various input and output (I/O) devices, such as a keyboard, a mouse, and a video display. The information handling system may also include one or more buses operable to transmit communications between the various hardware components.

In a particular embodiment, network switch 100 comprises a control plane 110 and a data plane 120. Control plane 110 represents a central processing unit (CPU) complex and operates to provide network discovery, mapping, and management based upon various protocols, and provides for differentiated service within network switch 100. For example, control plane 110 can perform network discovery and mapping based upon a shortest path first (SPF) or open shortest path first (OSPF) protocol, a peer-to-peer protocol (PPP), a neighbor discovery protocol (NDP), a border gateway protocol (BGP), or another network mapping and discovery protocol. Control plane 110 can also provide network management based upon a simple network management protocol (SNMP), a trivial file transfer protocol (TFTP), a Telnet session, or another network management protocol.

Data plane 120 includes ports 121-124, and a forwarding table 125. Forwarding table 125 includes a layer-2 table 126, a layer-3 table 127, a ternary content addressable memory (TCAM) 128, and one or more port tables 129. In a particular embodiment, forwarding table 125 represents a memory capacity of data plane 120, and is limited in size and is divided up between layer-2 table 126, layer-3 table 127, TCAM 128, and port table 129. For example, forwarding table 125 can have 32K entries that are divided such that each of tables 126-129 are allocated 8K entries, such that tables 126 and 127 are allocated 12K entries and tables 128 and 129 are allocated 4K entries, or tables 126-129 can have other allocations, as needed or desired. Data plane 120 represents an application specific integrated circuit (ASIC) that is suitable to receive information on an inbound interface, and to quickly make routing decisions for the information based upon the contents of forwarding table 125. Control plane 110 provides the contents of forwarding table 125 based upon the network discovery, mapping, and management activities described above.

Control plane 110 includes a real time operating system (RTOS) 130 that operates to perform the network discovery, mapping, and management activities. RTOS is virtualization capable and launches a data plane hypervisor 140. Data plane hypervisor 140 instantiates virtual data planes 142, 144, and 146 on network switch 100. In a particular embodiment, data plane hypervisor 140 is a part of RTOS 130. Each of virtual data planes 142, 144, and 146 provide a virtualized data plane capability for network switch 100, and represent a virtualization of the functions of the ASIC of data plane 120. As such, virtual data planes 142, 144, and 146 are shown as including forwarding tables for layer 2, layer 3, TCAM, and port table routing. Virtual data plane 142 is provided to manage layer 2 routing, virtual data plane 144 is provided to manage layer 3 routing, and virtual data plane 146 is provided to manage port table routing. When control plane 110 makes changes to layer 2 routing, the layer 2 table in virtual data plane 142 is changed, and the changes are provided to layer 2 table 126. Similarly, changes to layer 3 routing are made to the layer 3 table in virtual data plane 144 and are provided to layer 3 table 127, and changes to port table routing are made to the port table in virtual data plane 146 and are provided to port table 128.

In a particular embodiment, network switch 100 includes virtual data planes 142, 144, and 146 as a capability that is supplied on the network switch as supplied by the manufacturer of the network switch, and the functions of the virtual data planes are modifiable by modifying the network switch. For example, virtual data planes 142, 144, and 146 can be implemented in a non-volatile memory of network switch 100, such as a FLASH, and the virtual data planes can be modified via a firmware update to the network switch. In another embodiment, network switch 100 includes a hardware abstraction layer (HAL) 150 that permits applications 160, 165, and 170 to directly access virtual data planes 142, 144, and 146. Here, applications 160, 165, and 170 can directly modify the operation of virtual data planes 142, 144, and 146. Applications 160 and 165 operate on RTOS 130, and manage the operation of layer-2 table 126 and layer-3 table 127, respectively. Application 170 manages the operation of port table 129, and operates remotely from network switch 100. For example, application 160 can operate on a management server that is connected to network switch 100 via a management interface 175.

FIG. 2 illustrates a network environment 200, including servers 210, 215, 220, 225, 230, 235, 240, and 245, a network switch 250 similar to network switch 100, and a software defined network (SDN) controller 260. Each of servers 210, 215, 220, 225, 230, 235, 240, and 245 include an associated network interface card (NIC) 212, 217, 222, 227, 232, 237, 242, and 247, respectively. Servers 210, 215, 220, 225, 230, 235, 240, and 245 represent a variety of computing resources of network environment including data processing servers, network storage devices, local and wide area networks, or other resources as needed or desired. SDN controller 260 provides access to a data plane 252 of network switch 250, provides visibility into the switching paths of the network traffic through the data plane, and permits the switching paths to be modified and controlled remotely. SDN controller 260 establishes virtual data planes 254, and 256 on network switch 250, enabling the network switch to operate as two or more separate virtual switches. SDN controller 260 establishes a virtual local area network (VLAN) 262 session with virtual data plane 254 and a VLAN 264 session with virtual data plane 256. VLANs 262 and 264 permit secure communications between the SDN controller 260 and virtual data planes 254 and 256. An example of an SDN includes a network that is controlled by an OpenFlow protocol, or another switching network instantiated in software.

SDN controller 260 establishes a VLAN 255 session on virtual data plane 254, and maps server 210 to VLAN 255 port 1, server 220 to VLAN 255 port 2, and server 240 to VLAN 255 port 3. SDN controller 260 establishes a VLAN 257 session on virtual data plane 256, and maps server 230 to VLAN 257 port 4, server 235 to VLAN 257 port 5, and server 245 to VLAN 257 port 6. Also, SDN controller 260 establishes a VLAN 253 session on data plane 252, and maps server 215 to server 225 on VLAN 253. Thus network switch 250 supports hybrid switching, including switching on data plane 252, on virtual data plane 254, and on virtual data plane 256. Table 1 illustrates the hybrid switching of FIG. 2.

TABLE 1
Hybrid Switch Forwarding Table

| PORT | A | B | C | D | E | F | G | H |
|---|---|---|---|---|---|---|---|---|
| vPORT | 1 | — | 2 | — | 4 | 5 | 3 | 6 |
| VLAN | 1 | — | 1 | — | 2 | 2 | 1 | 2 |

In another embodiment, SDN controller 260 configures network switch 250 to provide switching on data plane 252 and virtual data planes 254 and 256 that is based upon more advanced switching criteria, such as tuple based switching for various fields of received packets. Table 2 illustrates tuple based switching. Here, in addition to virtual ports and VLANs, data plane 252 examines tuples of received packets to determine the routing behavior of network switch 100. For example, the network on virtual data plane 254 can be a private network, such that servers 210, 220, and 240 are further limited in that only packets with a source Internet protocol (IP) address of a.b.c.d, and a destination IP address of w.x.y.z are forwarded, and all other packets are dropped. The network on data plane 252 can be an access to a public network, such as the Internet, and packets can thus be routable to any IP address. Also, the network on virtual data plane 256 can be a web server, such that servers 230, 235, and 245 can receive packets from any source IP address and that have a destination address of m.n.o.p, and all other packets are dropped. The skilled artisan will understand that routing based upon other tuples is possible, as needed or desired. For example routing behavior in data plane 252 and in virtual data planes 254 and 256 can be based upon the Ether type of a received packet, a type of service for the data stream, a level 2, level 3, or level 4 header of a received packet, another type of differentiator of packets or streams, or a combination thereof.

TABLE 2
Tuple-Based Switch Forwarding Table

| PORT | A | B | C | D | E | F | G | H |
|---|---|---|---|---|---|---|---|---|
| vPORT | 1 | — | 2 | — | 4 | 5 | 3 | 6 |
| VLAN | 1 | — | 1 | — | 2 | 2 | 1 | 2 |
| SrcMAC | NIC A | NIC B | NIC C | NIC D | NIC E | NIC F | NIC G | NIC H |
| DstMAC | NIC C | NIC D | NIC A | NIC B | NIC F | NIC E | NIC A | NIC E |
| | NIC G | | NIC G | | NIC H | NIC H | NIC C | NIC F |
| SrcIP | a.b.c.d | e.f.g.h | a.b.c.d | e.f.g.h | — | — | a.b.c.d | — |
| DstIP | w.x.y.z | — | w.x.y.z | — | m.n.o.p | m.n.o.p | w.x.y.z | m.n.o.p |

In another embodiment, illustrated in Table 3, network switch 200 is configured to map various tunneling mechanisms and encapsulations. As such, each virtual port is associated with a different tunneling mechanism. Moreover, data plane 252 can operate to de-capsulate packets such that virtual data planes 254 and 256 receive just the payload. For example, the network on data plane 252 can be configured to provide access for generic routing encapsulation (GRE). The network on virtual data plane 254 can be configured such that virtual port 1 supports multiple VLAN headers embedded in a packet (for example “QinQ” traffic), virtual port 2 supports Level 2 over Level 3 encapsulation, and virtual port 3 supports voice over IP (VoIP) encapsulated traffic. Other tunneling protocols can be supported as needed or desired.

TABLE 3
Hybrid Switch Forwarding Table

| PORT | A | B | C | D | G |
|---|---|---|---|---|---|
| vPORT | 1 | — | 2 | — | 3 |
| Tunnel Type | Q in Q | GRE | L2 over L3 | GRE | VoIP |

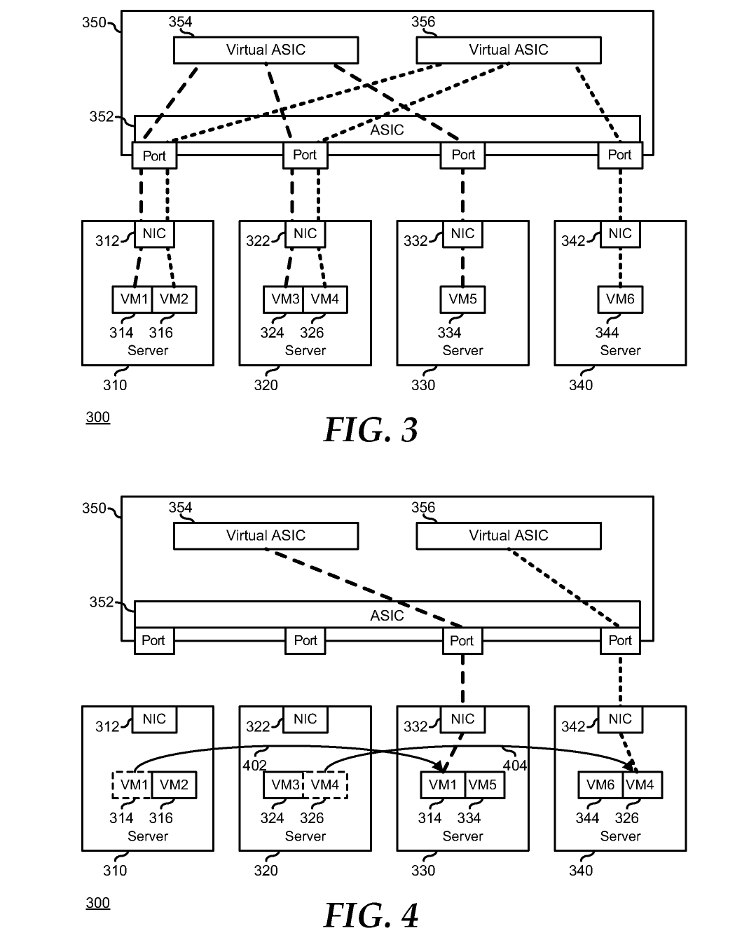

FIGS. 3 and 4 illustrate a network environment 300 similar to network environment 200, including servers 310, 320, 330, and 340, and a network switch 350 similar to network switches 100 and 250. Each of servers 310, 320, 330, and 340 include an associated NIC 312, 322, 332, and 342, respectively. Servers 310, 320, 330, and 340 include virtualization capable operating systems, such as a virtual machine manager or a hypervisor, that launch virtual machines 314 and 316 on server 310, virtual machines 324 and 326 on server 320, virtual machine 334 on server 330, and virtual machine 344 on server 340. Network environment 300 can include an SDN controller that provides access to a data plane 352 of network switch 350, provides visibility into the switching paths of the network traffic through the data plane, and permits the switching paths to be controlled remotely. Network switch 350 includes virtual data planes 354 and 356 that enable the network switch to operate as two or more separate virtual switches. A first VLAN is established on virtual data plane 354 that maps to virtual machines 314, 324, and 334, and a second VLAN is established on virtual data plane 356 that maps to virtual machines 316, 326, and 344. In FIG. 4, virtual machine 314 is migrated 402 to serve 330, and virtual machine 326 is migrated 404 to server 340. Note that, because VM 314 was mapped through data plane 352 to virtual data plane 354 before migration 402, then after the migration no changes to the forwarding tables of the data plane are needed to continue mapping the virtual machine to the virtual data plane. Similarly, because VM 326 was mapped through data plane 352 to virtual data plane 356 before migration 404, then after the migration no changes to the forwarding tables of data plane are needed to continue mapping the virtual machine to the virtual data plane.

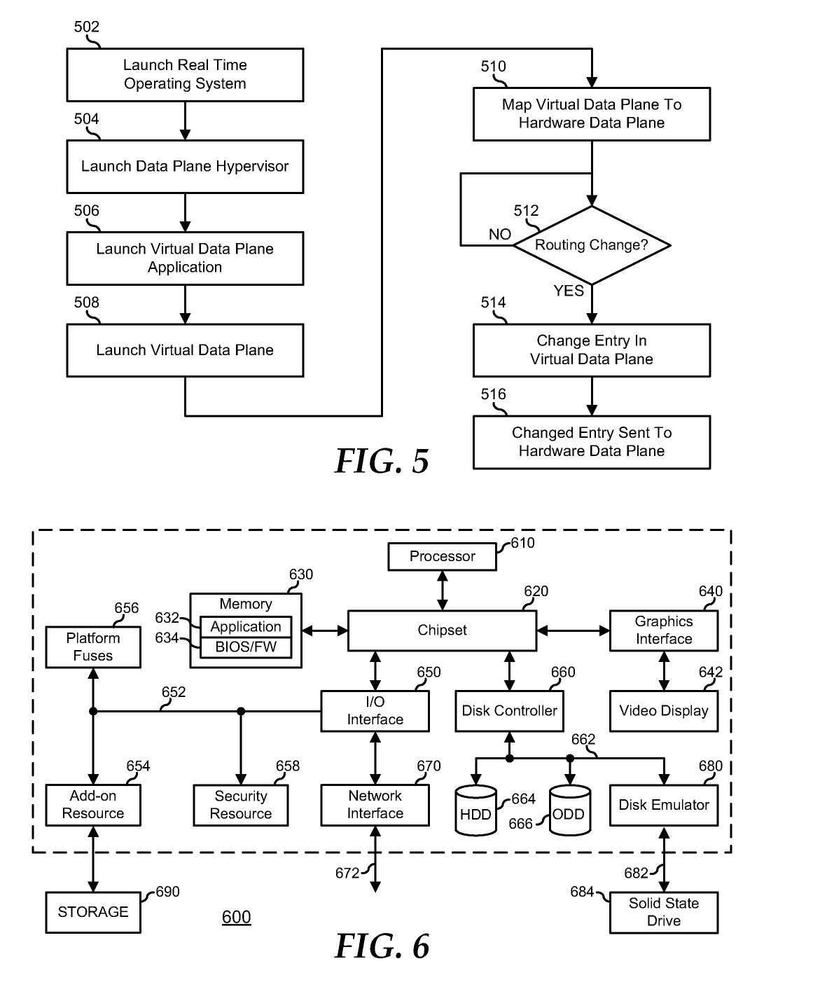

FIG. 5 illustrates a method of data plane virtualization in a network switching device, beginning at block 502 where an RTOS is launched on a network switching device. For example, RTOS 130 can be launched on network switching device 100 when the network switching device is powered on. A data plane hypervisor is launched on the network switching device in block 504. For example, data plane hypervisor 140 can be launched onto RTOS 130. If the data plane hypervisor is a part of the RTOS, then this step of the method is optional. A virtual data plane application is launched in block 506. Here, one or more of applications 160 and 165 can be launched on RTOS 130, or application 170 can be launched remotely from network switching device 100. A virtual data plane is launched on the network switching device in block 508. Here for example one or more of virtual data planes 142, 144, and 146 can be launched as a part of the powering on of network switching device 100, or can be launched in response to an action by one or more of applications 160, 165, and 170.

A table or a sub-table of the virtual data plane is mapped to a hardware data plane of the network switching device in block 510. For example, the level-2 sub-table of virtual control block 142 can be mapped to layer-2 sub-table 126. A decision is made as to whether or not there have been any routing changes in decision block 512. For example, control plane 110 can perform network discovery, mapping, and management operations that result in changes to the routing configuration of a network. If there have not been any routing changes, the “NO” branch of decision block 512 is taken and the method loops through decision block 512 until there are routing changes. When there have been any routing changes, the “YES” branch of decision block 512 is taken, and an entry in the virtual data plane is changed in block 514. For example, an entry of the port table sub-table of virtual data plane 146 can be changed in response to routing changes in the network. The changed entry from block 514 is provided to the appropriate table or sub-table of the hardware data plane in block 516. For example, the changed entry in virtual data plane 146 can be provided to the associated entry in hardware data plane 142.

FIG. 6 is a block diagram illustrating an embodiment of an information handling system 600, including a processor 610, a chipset 620, a memory 630, a graphics interface 640, an input/output (I/O) interface 650, a disk controller 660, a network interface 670, and a disk emulator 680. In a particular embodiment, information handling system 600 is used to carry out one or more of the methods described herein. In another embodiment, one or more of the systems described herein are implemented in the form of information handling system 600.

Chipset 620 is connected to and supports processor 610, allowing the processor to execute machine-executable code. In a particular embodiment, information handling system 600 includes one or more additional processors, and chipset 620 supports the multiple processors, allowing for simultaneous processing by each of the processors and permitting the exchange of information among the processors and the other elements of the information handling system. Chipset 620 can be connected to processor 610 via a unique channel, or via a bus that shares information among the processor, the chipset, and other elements of information handling system 600.

Memory 630 is connected to chipset 620. Memory 630 and chipset 620 can be connected via a unique channel, or via a bus that shares information among the chipset, the memory, and other elements of information handling system 600. In another embodiment (not illustrated), processor 610 is connected to memory 630 via a unique channel. In another embodiment (not illustrated), information handling system 600 includes separate memory dedicated to each of the one or more additional processors. A non-limiting example of memory 630 includes static random access memory (SRAM), dynamic random access memory (DRAM), non-volatile random access memory (NVRAM), read only memory (ROM), flash memory, another type of memory, or any combination thereof.

Graphics interface 640 is connected to chipset 620. Graphics interface 640 and chipset 620 can be connected via a unique channel, or via a bus that shares information among the chipset, the graphics interface, and other elements of information handling system 600. Graphics interface 640 is connected to a video display 642. Other graphics interfaces (not illustrated) can also be used in addition to graphics interface 640 as needed or desired. Video display 642 includes one or more types of video displays, such as a flat panel display, another type of display device, or any combination thereof.

I/O interface 650 is connected to chipset 620. I/O interface 650 and chipset 620 can be connected via a unique channel, or via a bus that shares information among the chipset, the I/O interface, and other elements of information handling system 600. Other I/O interfaces (not illustrated) can also be used in addition to I/O interface 650 as needed or desired. I/O interface 650 is connected via an I/O interface 652 to one or more add-on resources 654. Add-on resource 654 is connected to a storage system 690, and can also include another data storage system, a graphics interface, a network interface card (NIC), a sound/video processing card, another suitable add-on resource or any combination thereof. I/O interface 650 is also connected via I/O interface 652 to one or more platform fuses 656 and to a security resource 658. Platform fuses 656 function to set or modify the functionality of information handling system 600 in hardware. Security resource 658 provides a secure cryptographic functionality and includes secure storage of cryptographic keys. A non-limiting example of security resource 658 includes a Unified Security Hub (USH), a Trusted Platform Module (TPM), a General Purpose Encryption (GPE) engine, another security resource, or a combination thereof.

Disk controller 660 is connected to chipset 620. Disk controller 660 and chipset 620 can be connected via a unique channel, or via a bus that shares information among the chipset, the disk controller, and other elements of information handling system 600. Other disk controllers (not illustrated) can also be used in addition to disk controller 660 as needed or desired. Disk controller 660 includes a disk interface 662. Disk controller 660 is connected to one or more disk drives via disk interface 662. Such disk drives include a hard disk drive (HDD) 664, and an optical disk drive (ODD) 666, and can include one or more disk drive as needed or desired. ODD 666 can include a Read/Write Compact Disk (R/W-CD), a Read/Write Digital Video Disk (R/W-DVD), a Read/Write mini Digital Video Disk (R/W mini-DVD, another type of optical disk drive, or any combination thereof. Additionally, disk controller 660 is connected to disk emulator 680. Disk emulator 680 permits a solid-state drive 684 to be coupled to information handling system 600 via an external interface 682. External interface 682 can include industry standard busses such as USB or IEEE 1394 (Firewire) or proprietary busses, or any combination thereof. Alternatively, solid-state drive 684 can be disposed within information handling system 600.

Network interface device 670 is connected to I/O interface 650. Network interface 670 and I/O interface 650 can be coupled via a unique channel, or via a bus that shares information among the I/O interface, the network interface, and other elements of information handling system 600. Other network interfaces (not illustrated) can also be used in addition to network interface 670 as needed or desired. Network interface 670 can be a network interface card (NIC) disposed within information handling system 600, on a main circuit board such as a baseboard, a motherboard, or any combination thereof, integrated onto another component such as chipset 620, in another suitable location, or any combination thereof. Network interface 670 includes a network channel 672 that provide interfaces between information handling system 600 and other devices (not illustrated) that are external to information handling system 600. Network interface 670 can also include additional network channels (not illustrated).

Information handling system 600 includes one or more application programs 632, and Basic Input/Output System and Firmware (BIOS/FW) code 634. BIOS/FW code 634 functions to initialize information handling system 600 on power up, to launch an operating system, and to manage input and output interactions between the operating system and the other elements of information handling system 600. In a particular embodiment, application programs 632 and BIOS/FW code 634 reside in memory 630, and include machine-executable code that is executed by processor 610 to perform various functions of information handling system 600. In another embodiment (not illustrated), application programs and BIOS/FW code reside in another storage medium of information handling system 600. For example, application programs and BIOS/FW code can reside in HDD 664, in a ROM (not illustrated) associated with information handling system 600, in an option-ROM (not illustrated) associated with various devices of information handling system 600, in storage system 690, in a storage system (not illustrated) associated with network channel 672, in another storage medium of information handling system 600, or a combination thereof. Application programs 632 and BIOS/FW code 634 can each be implemented as single programs, or as separate programs carrying out the various features as described herein.

In the embodiments described herein, an information handling system includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a consumer electronic device, a network server or storage device, a switch router, wireless router, or other network communication device, a network connected device (cellular telephone, tablet device, etc.), or any other suitable device, and can vary in size, shape, performance, price, and functionality. The information handling system can include memory (volatile (e.g. random-access memory, etc.), nonvolatile (read-only memory, flash memory etc.) or any combination thereof), one or more processing resources, such as a central processing unit (CPU), a graphics processing unit (GPU), hardware or software control logic, or any combination thereof. Additional components of the information handling system can include one or more storage devices, one or more communications ports for communicating with external devices, as well as, various input and output (I/O) devices, such as a keyboard, a mouse, a video/graphic display, or any combination thereof. The information handling system can also include one or more buses operable to transmit communications between the various hardware components. Portions of an information handling system may themselves be considered information handling systems.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The device or module can include software, including firmware embedded at a device, such as a Pentium class or PowerPC™ brand processor, or other such device, or software capable of operating a relevant environment of the information handling system. The device or module can also include a combination of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A network switching device comprising:
a hardware data plane including a forwarding table, the forwarding table comprising a first sub-table; and
a control plane including:
a processor; and
a first virtual data plane comprising a first virtual sub-table;
wherein the processor maps changes in the first virtual sub-table to the first sub-table.

2. The network switching device of claim 1, wherein:
the forwarding table further comprises a second sub-table;
the first virtual data plane comprises a second virtual sub-table; and
the processor maps changes in the second virtual sub-table to the second sub-table.

3. The network switching device of claim 1, wherein:
the forwarding table further comprises a second sub-table;
the control plane further includes a second virtual data plane, the second virtual data plane comprising a second virtual sub-table; and
the processor maps changes in the second virtual sub-table to the second sub-table.

4. The network switching device of claim 3, wherein the first virtual data plane manages layer-2 switching and the second virtual data plane manages layer-3 switching.

5. The network switching device of claim 3, wherein:
the control plane further comprises a first application, the first application changes a first entry in the first virtual sub-table.

6. The network switching device of claim 5, wherein:
a second application remote from the network switching device changes a second entry in the second virtual sub-table.

7. The network switching device of claim 6, wherein:
the control further comprises a hardware abstraction layer;
the first application changes the first entry via the hardware abstraction layer; and
the second application changes the second entry via the hardware abstraction layer.

8. The network switching device of claim 3, wherein:
a software defined network controller remote from the network switching device changes a first entry in the first virtual sub-table and a second entry in the second virtual sub-table.

9. The network switching device of claim 8, wherein:
the software defined network controller changes a third entry in a third sub-table of the forwarding table of the hardware data plane.

10. The network switching device of claim 1, wherein:
the hardware data plane further includes a first port and a second port;
a first entry of the first sub-table maps a virtual machine from the first port to a second entry of the first virtual sub-table; and
in response to the virtual machine being migrated to the second port, the first entry maps the virtual machine from the second port to the second entry.

11. A method comprising:
launching a first virtual data plane on a network switching device;
mapping a first virtual table of the first virtual data plane to a first table of a hardware data plane of the network switching device:
changing a first entry of the first virtual table; and
changing a second entry of the first table in response to changing the first entry, wherein the second entry corresponds to the first entry.

12. The method of claim 11, further comprising:
mapping a second virtual table of the first virtual data plane to a second table of the hardware data plane:
changing a third entry of the second virtual table; and
changing a fourth entry of the second table in response to changing the third entry, wherein the fourth entry corresponds to the third entry.

13. The method of claim 11, further comprising:
launching a second virtual data plane on the network switching device;
mapping a second virtual table of the second virtual data plane to a second table of the hardware data plane:
changing a third entry of the second virtual table; and
changing a fourth entry of the first table in response to changing the third entry, wherein the fourth entry corresponds to the third entry.

14. The method of claim 13, further comprising:
launching a first application on the network switching device:
wherein mapping the first virtual table to the first table is in response to launching the first application.

15. The method of claim 14, wherein mapping the second virtual table to the second table is in response to a second application that is remote from the network switching device.

16. The method of claim 13, wherein changing the first entry and changing the third entry are in response to a software defined network controller that is remote from the network switching device.

17. The method of claim 11, further comprising:
launching a data plane hypervisor on the network switching device;
wherein launching the first virtual data plane is in response to launching the data plane hypervisor.

18. A non-transitory computer readable medium comprising code for carrying out a method, the method comprising:
launching a first virtual data plane on a network switching device;
mapping a first virtual table of the first virtual data plane to a first table of a hardware data plane of the network switching device:
changing a first entry of the first virtual table; and
changing a second entry of the first table in response to changing the first entry, wherein the second entry corresponds to the first entry.

19. The computer readable medium of claim 18, the method further comprising:
launching a first virtual data plane on a network switching device;
mapping a first virtual table of the first virtual data plane to a first table of a hardware data plane of the network switching device:
changing a first entry of the first virtual table; and
changing a second entry of the first table in response to changing the first entry, wherein the second entry corresponds to the first entry.

20. The computer readable medium of claim 18, the method further comprising:
mapping a second virtual table of the first virtual data plane to a second table of the hardware data plane:
changing a third entry of the second virtual table; and
changing a fourth entry of the second table in response to changing the third entry, wherein the fourth entry corresponds to the third entry.
